(19) United States
(12) Patent Application Publication
(10) Pub. No.: US 2007/0138355 A1
(43) Pub. Date: Jun. 21, 2007

(54) Special pivoting support for a purple martin house

(76) Inventor: Timothy W. Maurer, Selma, IN (US)

Correspondence Address: RITCHISON LAW OFFICES, PC;John D. Ritchison, Suite A, 115 East Ninth Street, Anderson, IN, 46016-1509, US

(21) Appl. No.: 11/633,773

(22) Filed: Dec. 5, 2006

Related U.S. Application Data
(60) Provisional application No. 60/751,171, filed on Dec. 16, 2005.

(51) Int. Cl. F16L 3/00

(52) U.S. Cl. 248/121

(57) ABSTRACT

An elevating and lowering device for supporting and accessing a Purple Martin birdhouse. This device permits the ease of supporting the birdhouse and alleviates extra effort and time in elevating and lowering the purple martin house. The device may be easily used to vertically and securely support the house, then when necessary return the house to a ground location, by means of the pivotal features, for access to survey or re-feed the birds. The preferred embodiment is comprised of several structural members, namely a secured martin house support which pivots for use, an extended pole, a support channel with pivoting and counterbalance features, and a foundation means for securing the device to various options such as to the ground, to a fence, or to a balcony.

### CROSS-REFERENCE TO RELATED APPLICATIONS:

This application claims the benefit of Provisional Patent Application Ser. No. 60/751,171 filed Dec. 16, 2005 by Timothy W. Maurer and titled “SPECIAL PIVOTING SUPPORT FOR A PURPLE MARTIN HOUSE”.

### FIELD OF INVENTION

This invention relates to SPECIAL PIVOTING SUPPORT FOR A PURPLE MARTIN HOUSE and the like. Particularly this support is related to those special supports that have pivoting features built into the secure device to functionally aid in the use of the purple martin bird house placed on the new support device.

### FEDERALLY SPONSORED RESEARCH

None.

### SEQUENCE LISTING OR PROGRAM

None.

### BACKGROUND-FIELD OF INVENTION

The new SPECIAL PIVOTING SUPPORT FOR A PURPLE MARTIN HOUSE device described in this specification is a mechanism that is designed to support various bird houses, especially those for Purple Martins.

A. Introduction of the Problems Addressed

Traditionally, the support for high bird houses has been a very long, stationary pole device that is unwieldy and difficult to handle. Often, the houses would not swing free so that feed, and nest of eggs or birds tumbled out and were destroyed when one attempted to inspect or service the house. Some attempts to improve the long pole support were provided by a telescoping unit which is still unwieldy for most people. Other attempts to improve included complex cable and pulley systems to raise and lower the bird house.

This new and improved SPECIAL PIVOTING PURPLE MARTIN HOUSE SUPPORT permits the ease of supporting the bird house and alleviates extra effort and time in elevating and lowering the purple martin house. Specifically, the SPECIAL PIVOTING SUPPORT FOR A PURPLE MARTIN HOUSE provides a device that may be easily used to vertically and securely support the house, then when necessary retrieve the house to a ground location for access to survey the birds or re-supply feed for the birds.

B. Prior Art

As mentioned earlier, the historical technology focused mainly on telescoping poles and cable systems. Several devices have attempted to improve upon the unwieldy process and other limitations. However, for the problems as stated the prior art devices were often complex, difficult to install and limited in use. The advantages and objectives of the new SPECIAL PIVOTING SUPPORT FOR A PURPLE MARTIN HOUSE is stated below in detail. This new device addresses these limitations and provides a solution to the stated problems.

Examples of prior bird house support devices begin with U.S. Pat. No. 1,516,381 issued to A. C. Erickson (1922). This invention teaches a single pole with a “horizontal cross or cruciform” as a support for the house. The support pole attaches to the cross, which in turn supports the house. No claim or description of a manner to easily lower the house is taught. No swing or pivot is shown to keep the house vertical during movement. Next, is U.S. Pat. No. 3,111,934 issued to A. E. Vail (1963) which teaches a bird house with a clean-out door that is supported rigidly to a pole. No pivoting or lowering means is established by the specification or claimed by the invention.

The next patent issued in this general field is the U.S. Pat. No. 3,367,632 issued to A. E. Vail (1966) called a raising and lowering mechanism for a birdhouse. It is a multi-layered bird house that teaches a telescoping support pole with several clamping means. It is raised and lowered by a cable system with a rotating handle and pulley system. The whole device is far more complex and costly to manufacture than the present new SPECIAL PIVOTING SUPPORT FOR A PURPLE MARTIN HOUSE. Another support device for a bird house issued to R. Bruhns is taught in U.S. Pat. No. 3,696,792 (1972). This device shows another telescoping pole system with the full weight of the house held in the vertical pole. There is no offset or counter weights involved. The control and use of this device is cumbersome and difficult unless the person has sufficient strength to raise and lift the house while operating the clamping handle. The telescoping members allow disassembly for shipping but are ill equipped to provide easy use in operation due to the purely vertical configuration.

A U.S. Pat. No. 3,792,685 issued to E. Weiner (1974) was focused at keeping the house upright on the pole. The vertical pole extends through the martin house and is affixed to the house by a cable system that permits lowering the house to ground level for attending. The bird house support system requires the cable system, a pole, a pipe attached to the house and cable that “slides” up and down the pull, and a securing means to hold the house in position. This cable and pole system again is significantly more complex in configuration and more difficult to use than the SPECIAL PIVOTING SUPPORT FOR A PURPLE MARTIN HOUSE. The U.S. Pat. No. 3,814,059 issued to J. K. Eickhof (1974) teaches a hydraulic lift system to raise and lower a support platform for a birdhouse. The device is somewhat easier to use than the cable and telescoping devices but adds complexity and cost to the overall device.

Another elevator locking and release device for a birdhouse is shown in the U.S. Pat. No. 3,986,480 issued to A. E. Vail in 1976. The apparatus has a locking device in the base of the house and a cable and pole system similar to other devices of prior art. The house used must permit the pole to run interior to the overall house. Again, the complexity and cost exceeds that taught by the SPECIAL PIVOTING SUPPORT FOR A PURPLE MARTIN HOUSE. Another device is revealed by the U.S. Pat. No. 4,765,277 issued to Bailey et al (1988). This device is a telescopic system without ostensible raising and lowering aids. The weight of the birdhouse would be limited or the forces needed to raise and lower the device would exceed a reasonably strong person's ability to use this device. The simplicity has removed the strength and usefulness in comparison with the newer device shown here. Another limitation is the significant staking depth required to stabilize this device.

The device shown in U.S. Pat. No. 4,819,584 by D. Rozumek (1989) portrays a pivoting device to engage raise and lower the house. When vertical, the house remains free swinging and open to “whipping” in the wind. There is no counterbalance to offset the weight of the device when raising and lowering. The weighted concrete collar eliminates the ability to mount the device on a fence post if desired. The whole system will either be too heavy to usefully operate, or so light that it is unable to withstand wind loads as compared to the present new SPECIAL PIVOTING SUPPORT FOR A PURPLE MARTIN HOUSE. The multiple birdhouse assembly shown in the U.S. Pat. No. 5,560,314 issued in 1996 to P. E. Wessinger portrays a cable operated system to raise and lower the birdhouses. There is no platform taught or claimed for a Purple Martin house. The system has some value but varies significantly in the apparent overall structural strength as compared to the configuration of the SPECIAL PIVOTING SUPPORT FOR A PURPLE MARTIN HOUSE.

Another telescoping birdhouse device is taught by D. R. McClasky in the U.S. Pat. No. 6,009,837 issued in 2000. This birdhouse and support pole teaches a telescoping tube, with mechanical detents and fastening means. The pole is various sizes as it needs to have the telescoping feature. The full weight of the house is required to be lifted during operation and has no counterbalancing or assist means as the new Maurer device teaches. The concept lacks a robust assist and would be difficult in actual use to with a birdhouse atop the pole system. The “wind” action might also effect the ability of the mechanical fasteners to maintain engagement. The present Maurer device has secure engagements to resist actions from the anticipated wind loads. It also has a constant cross-section for the pole to permit structural efficiency of the design. Another birdhouse support means is taught by the U.S. Pat. No. 6,401,658 issued to W. B. Teets in 2002. This device shows a removable pin that permits the raising and lowering of the house for access and re-supply of food. The device is limited by configuration to lesser heights than any shown by the Maurer device. Additionally, the raising and lowering has the full weight in the vertical plane as opposed to the counterbalance assist shown with the new SPECIAL PIVOTING SUPPORT FOR A PURPLE MARTIN HOUSE.

As far as known, there are no support devices at the present time which fully meet this need with as few components and superior operation as the present pivotal support device. It is believed that this device is made with fewer parts, of a more durable design, and with much improved support and structural capabilities than any previous pivotal support devices.

### SUMMARY OF THE INVENTION

A SPECIAL PIVOTING SUPPORT FOR A PURPLE MARTIN HOUSE has been developed for use by a person to support various bird houses, especially those for Purple Martins. Traditionally, the support has been a very long, stationary pole device that is unwieldy and difficult to handle. Some attempts to improve the long pole support were provided by a telescoping unit which is still unwieldy for most people. This new and improved SPECIAL PIVOTING PURPLE MARTIN HOUSE SUPPORT permits the ease of supporting the bird house and alleviates extra effort and time in elevating and lowering the purple martin house. Specifically, the SPECIAL PIVOTING SUPPORT FOR A PURPLE MARTIN HOUSE provides a device that may be easily used to vertically and securely support the house, then when necessary retrieve the house to a ground location for access to survey the birds or re-supply feed for the birds.

The preferred embodiment of the device is comprised of several structural members namely a secured martin house support which pivots for use, an extended pole and support channel with pivoting and counterbalance features, and a foundation means for securing the SPECIAL PIVOTING SUPPORT FOR A PURPLE MARTIN HOUSE to several options such as to the ground, to a fence, or to a balcony. While the three main structures are securely connected when in the house is in the elevated position, the overall structure contains pivotal connections for lowering the martin house to the ground.

The newly invented SPECIAL PIVOTING SUPPORT FOR A PURPLE MARTIN HOUSE device features common, readily available parts. In operation, the new SPECIAL PIVOTING SUPPORT FOR A PURPLE MARTIN HOUSE device may be assembled and operated with common fasteners and tools.

### OBJECTS AND ADVANTAGES

There are several objects and advantages of the SPECIAL PIVOTING SUPPORT FOR A PURPLE MARTIN HOUSE device. There currently exist few mechanisms that permit a secure elevation of the martin house that also permits access to the martin house for inspection of the birds and re-supplying the bird feed.

One advantage and object of the present invention is that is easy to use and quick to swivel to the ground. This means the SPECIAL PIVOTING SUPPORT FOR A PURPLE MARTIN HOUSE can be used by a person of small stature or one with some disability. The counterbalance of the main extension pole permits quick lowering of the house while the pivotal house support allows the purple martin house to always remain horizontal to the ground level. Hence the feed and birds maybe accessed and be virtually undisturbed. Another advantage is that the device is versatile. It may be used several ways, for example as a ground mount on a solid foundation, on a balcony or deck rail, on a fence pole as an extension, and various other ways. Another object for the SPECIAL PIVOTING SUPPORT FOR A PURPLE MARTIN HOUSE device is to provide a device with more simple and common hardware than prior art. The device has common fasteners and structural members so that manufacturing may benefit from economy of scale for most of the materials.

A further advantage is the counterbalanced portion of the pole which helps the effort required by the user. Additionally, the pole is not interior to the Martin House so that regular or existing houses may be used with this device.

Another object of the present invention to be durable when used. The locking features of all the members, the structural material and the member coatings provide significant improvement in providing a sturdy device that will last many years in use with little service required.

Finally, other advantages and additional features of the present SPECIAL PIVOTING SUPPORT FOR A PURPLE MARTIN HOUSE device will be more apparent from the accompanying drawings and from the full description of the device. For one skilled in the art of devices and improvements for supporting and mounting bird houses and such, it is readily understood that the features shown in the examples with this mechanism are readily adapted to other types of support improvements.

### DESCRIPTION OF THE DRAWINGS—FIGURES

The accompanying drawings, which are incorporated in and constitute a part of this specification, illustrate an embodiment of the SPECIAL PIVOTING SUPPORT FOR A PURPLE MARTIN HOUSE device that is preferred. The drawings together with the summary description given above and a detailed description given below serve to explain the principles of the SPECIAL PIVOTING SUPPORT FOR A PURPLE MARTIN HOUSE device. It is understood, however, that the SPECIAL PIVOTING SUPPORT FOR A PURPLE MARTIN HOUSE device is not limited to only the precise arrangements and instrumentalities shown.

FIGS. 1A through C are photographs of the first prototype assembly of the SPECIAL PIVOTING SUPPORT FOR A PURPLE MARTIN HOUSE device 31.

FIGS. 2A through 2C are photographs of the SPECIAL PIVOTING SUPPORT FOR A PURPLE MARTIN HOUSE device 31 with the various components noted.

FIGS. 3A through E are photographs of the SPECIAL PIVOTING SUPPORT FOR A PURPLE MARTIN HOUSE device 31 with the various components of the support structure noted.

FIG. 4 is the original sketch for producing a prototype of the SPECIAL PIVOTING SUPPORT FOR A PURPLE MARTIN HOUSE device 31.

FIGS. 5A through D are photographs and sketches of the uppermost structure including the pivotal house support 33 and its components.

FIG. 6 is a sketch of the prototype SPECIAL PIVOTING SUPPORT FOR A PURPLE MARTIN HOUSE device 31 at night time in its lowered position.

FIGS. 7A and 7B are sketches showing the mechanism of a typical pivotal extended pole in the middle section of a SPECIAL PIVOTING SUPPORT FOR A PURPLE MARTIN HOUSE device 31.

FIGS. 8A through 8F are sketches and photographs showing the detailed components for the pivotal mechanism for the pivotal extended pole 32.

FIGS. 9A and B are sketches of the lower section of the pivotal extended pole 32 including the detailed components for attaching the section 32 to the foundation structure.

FIGS. 10A through F are sketches of a pivotal extended pole 32 with a connection mechanism to attach it to the foundation structure.

FIGS. 11A through E are photographs and sketches of connection means between the pivotal extended pole 32 and the foundation structures.

FIGS. 12A through O are photographs of the preferred embodiment of the SPECIAL PIVOTING SUPPORT FOR A PURPLE MARTIN HOUSE device 31 in its full operation.

FIGS. 13A, B, and C are photographs of an alternative embodiment for mounting to a fence post or balcony rail.

FIGS. 14A through D are photographs of an operation of an alternative embodiment for a balcony or fence post as the foundation structure.

### DESCRIPTION OF THE DRAWINGS—REFERENCE NUMERALS

The following list refers to the drawings:
30 purple martin bird house structure
31 general assembly of the SPECIAL PIVOTING SUPPORT FOR A PURPLE MARTIN HOUSE device
32 pivotal extended support pole
33 pivotal support for house (30)
34 extended, counterbalanced pole
35 base support channel
36 pivot means
37 structural means to connect pivot (32) to house pivot means (33)
38 means to secure pivot (32) to house pivot (33)[strap or equal]
39 house (30) pivot means
40 angle adjust on pivot means (32)
41 midway guide on extended pole (34) for connection means (37)
42 bird house support pole perpendicular to support plate (43)
43 bird house support plate or platform
44 foundation support means
45 connection means to secure to a pole, fence post or equal
46 means to connect support channel (35) to foundation pole (45)
47 release pin
48 counter balance handle
49 foundation pole (fence or otherwise)
50 adjustment/engagement means for connection (46)
51 operator
52 house (30) inspection door
53 alternative support connector
54 preferred foundation system
55 base foundation receiving structure
56 apertures
57 concrete and gravel or equal

### DETAILED DESCRIPTION OF PREFERRED EMBODIMENT

The present device is a mechanism for a person to pivotally support bird houses called a SPECIAL PIVOTING SUPPORT FOR A PURPLE MARTIN HOUSE 31. The preferred embodiment of the device is comprised of several structural members namely a secured martin house support 33 which pivots for use; an pivotal extended support pole 32 comprised of an extended pole 34, a support channel 35, and fasteners—collectively together these provide pivoting and counterbalance features; and a foundation means 54 for securing the device 31. The SPECIAL PIVOTING SUPPORT FOR A PURPLE MARTIN HOUSE 31 has several options for securing the base such as to the ground, to a fence post or fence pole, or to a balcony. While the three main components are securely connected, the means of connection are by fasteners, welding, brazing or integral manufacturing processes depending on the materials used.

The improvement over the existing art is providing a device that:
a. is easy to use and quick to swivel to the ground;
b. is versatile;
c. is more simple and more common hardware;
d. is benefited in manufacturing from economy of scale for parts and materials;
e. is durable when used;
f. has a counterbalanced portion of the pole which helps the effort required by the user; and
g. is not interior to the Martin House so that regular or existing houses may be used with this device.

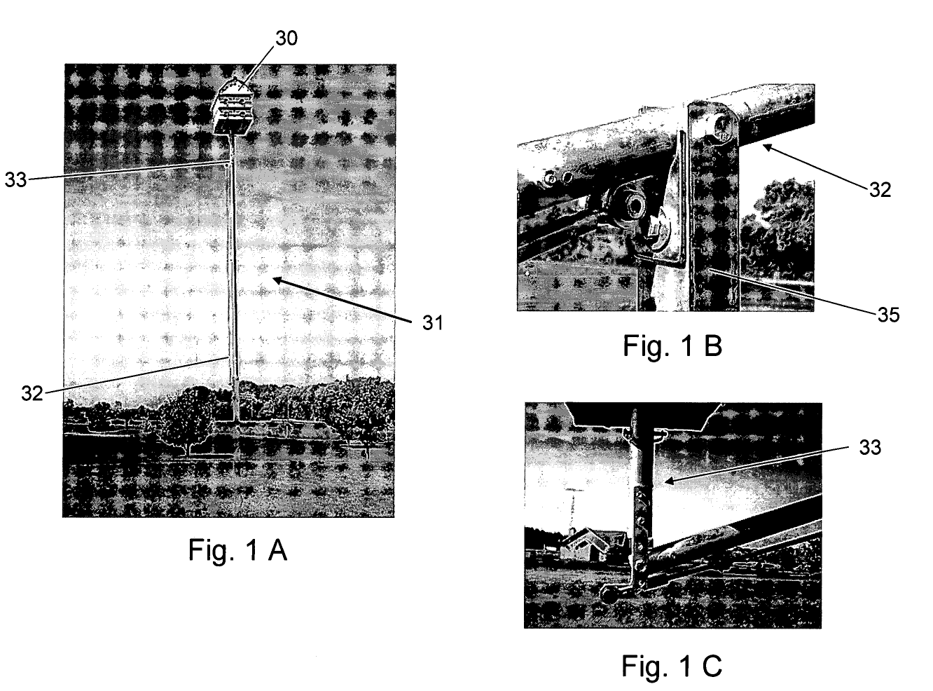

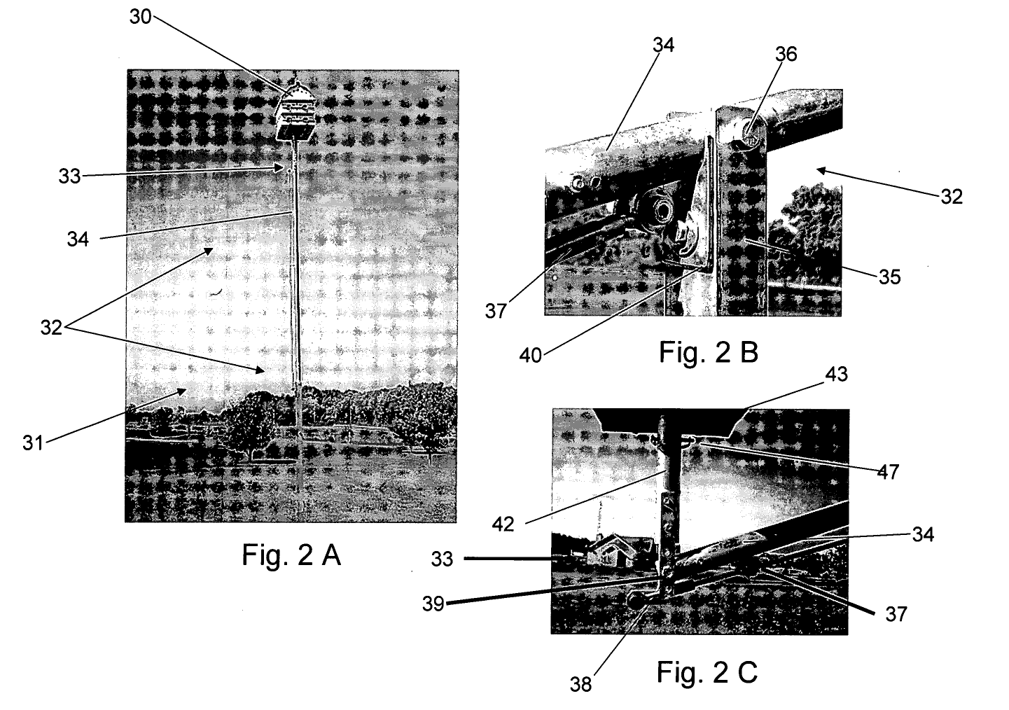

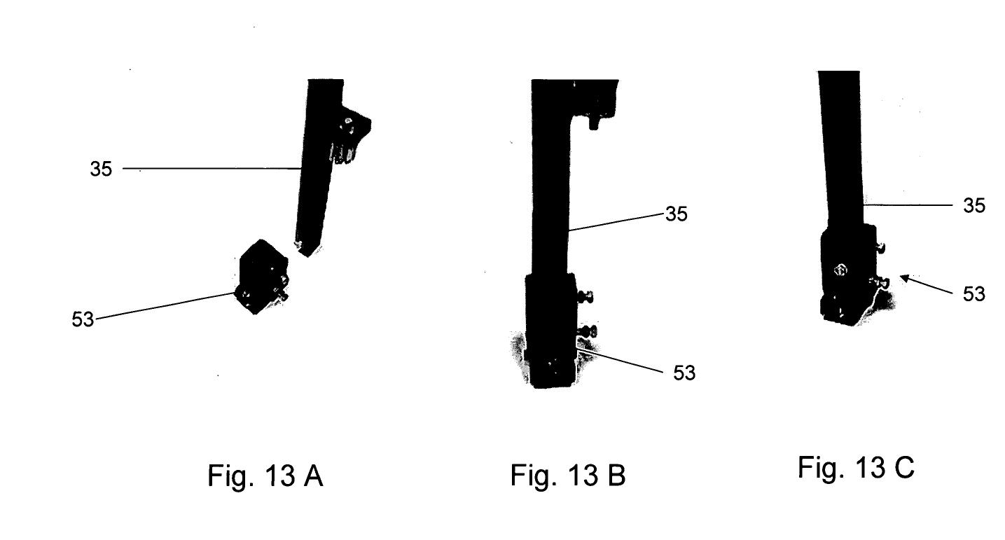

There is shown in FIGS. 1 through 11 and FIG. 13 a complete operative embodiment of the SPECIAL PIVOTING SUPPORT FOR A PURPLE MARTIN HOUSE 31. In the drawings and illustrations, one notes well that the FIGS. 1 through 11 and FIG. 13 demonstrate the general configuration of this invention. The preferred embodiment of the device is comprised of only a few parts as shown in the drawings. These structural members or parts include, but are not limited to, a secured martin house support 33 which pivots for use; an pivotal extended support pole 32 comprised of an extended pole 34, a support channel 35, and fasteners—collectively together these provide pivoting and counterbalance features; and a foundation means 54 for securing the device 31. Various important features of these member components are delineated in FIGS. 2 through 11 and in FIG. 13 of the drawings and are described below in appropriate detail for one skilled in the art to appreciate their importance and functionality to the SPECIAL PIVOTING SUPPORT FOR A PURPLE MARTIN HOUSE 31.

The accompanying drawings, which are incorporated in and constitute a part of this specification, illustrate an embodiment of the SPECIAL PIVOTING SUPPORT FOR A PURPLE MARTIN HOUSE 31 that is preferred. The drawings together with the summary description given above and a detailed description given below serve to explain the principles of the SPECIAL PIVOTING SUPPORT FOR A PURPLE MARTIN HOUSE 31. It is understood, however, that the SPECIAL PIVOTING SUPPORT FOR A PURPLE MARTIN HOUSE 31 is not limited to only the precise arrangements and instrumentalities shown.

FIGS. 1A through C are photographs of the first prototype assembly of the SPECIAL PIVOTING SUPPORT FOR A PURPLE MARTIN HOUSE device 31. Shown are a purple martin house 30, the general assembly of the SPECIAL PIVOTING SUPPORT FOR A PURPLE MARTIN HOUSE 31 in the extended (in an elevated position), the pivotal extended support pole 32 in a lowered position, and the pivotal support assembly 33 for the house 30 (in a lowered position).

FIGS. 2A through 2C are photographs of the SPECIAL PIVOTING SUPPORT FOR A PURPLE MARTIN HOUSE device 31 with the various components noted. In FIG. 2A, the martin house 30 is shown in the elevated position with the extended counter balanced pole 34 fully extended and vertical. This view demonstrates the pivotal pole support 32 and the pivotal house support 33 in the fully vertical and secured position. FIG. 2B shows the pivotal pole support 32 components. Here the pivot means 36 runs through the support channel 35 and the extended tube 34. The angle adjust 40 permits the angle between the channel 35 and the extender tube 34 to be varied and determined by the position of the angle adjust 40. Various common fasteners are used to connect the components. In addition, the structure means to connect the tube pivot 32 to the house pivot 33 is shown. This means 37 is adjusted to insure a rigid connection in order to secure the house 30 on the support plate 43. FIG. 2C shows the pivotal house support 33 details. Here the extended tube 34 is connected by the pivot means 39 through the house securing strap 38. The strap 38 is rigidly fastened to the house pole 42. The house support 43 is removably attached to the house pole 42 by a means 47 such as a release pin.

FIGS. 2A through C show various structural means. One skilled in the art of support structure understands well the various types of materials and coatings that may be used for making structures such as the SPECIAL PIVOTING SUPPORT FOR A PURPLE MARTIN HOUSE 31. These include, for example and not as a limitation, various round, oval, square, rectangular and other geometrically shapes tubes 34, 42, and 49. Likewise, the channel 35 might be a one-piece “C” configuration or a back and two sides. The channel 35 and tube materials may be metal(various steels, including stainless, black iron, etc, aluminum, etc. and may be cast, rolled or formed shets, etc); may be a composite material (such as various plastics, fiber glasses, and the like); or any elongated material capable of providing an elongated pivotal structure as described herein. For environmental protection from the weather elements, the structures may be powder coated, painted or surface treated to protect from the elements.

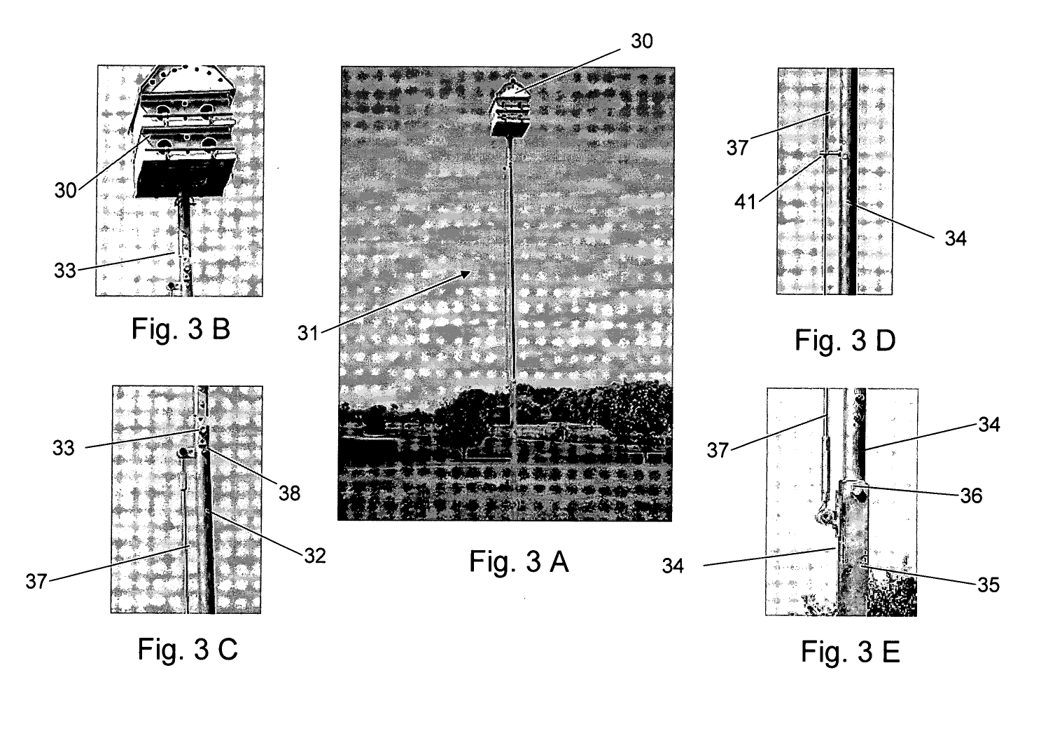

FIGS. 3A through E are photographs of the SPECIAL PIVOTING SUPPORT FOR A PURPLE MARTIN HOUSE device 31 with the various components of the support structure noted. FIG. 3A is the SPECIAL PIVOTING SUPPORT FOR A PURPLE MARTIN HOUSE 31 with the house 30 atop. FIG. 3B is the house 30 on the house support 33. FIG. 3C is the connection between the house support 33 and the extender pole 34. One notes well the securing means 38 as well as the connector means 37 which connects rigidly the means 38 and support 33 with the pivotal support pole 32. In FIG. 3D the middle section of the pole 34 is demonstrated with the guide 41 helping direct and secure the connector 37. The connector 37 is a structural device such as a heavy all-thread, conduit or pipe that has adjustability built into the ends such as a threaded device or equal. The cross section of the connector is large enough to provide wind resistance and stability to the device. FIG. 3E completes the connection 37 to the channel 35 along the tube 34. Note well the pivot mechanism 36 for pivotally securing the tube 34 to the channel 35.

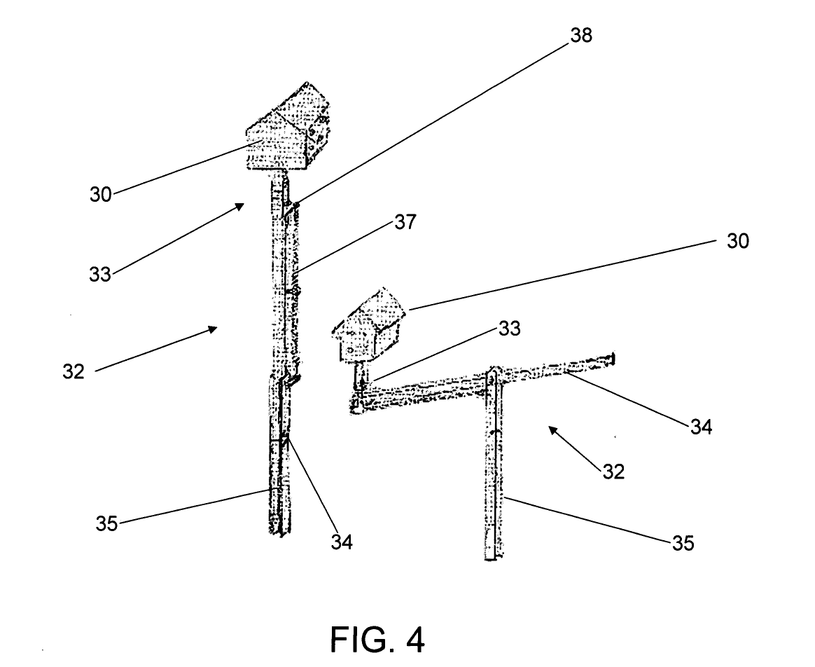

FIG. 4 are the original sketches for producing a prototype of the SPECIAL PIVOTING SUPPORT FOR A PURPLE MARTIN HOUSE device 31. All of the parts explained in the above prototype descriptions are shown again in these sketches.

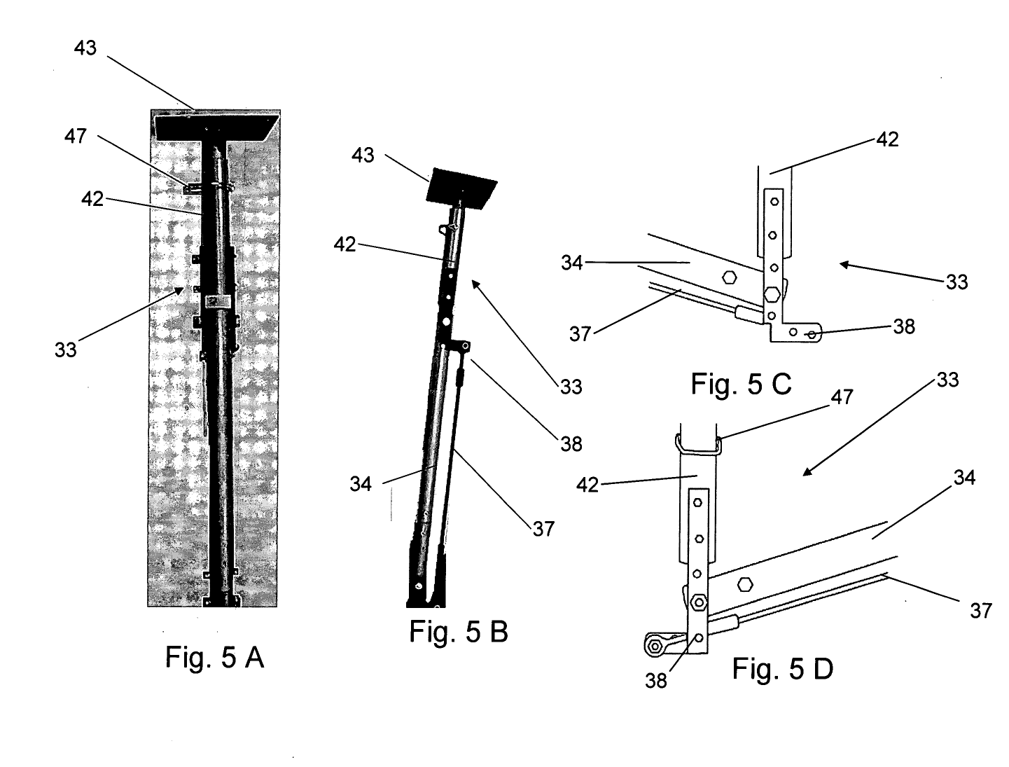

FIGS. 5A and B continue the photographs of the uppermost structure including the pivotal house support 33 and its components. The house support platform 43 is connected to the house tube 42 by means of a pin 47. The secure means 38 is adjusted by means of the connector 37. The extender tube 34 is pivotally connected to the house tube 42 by the pivotal support pole 33. FIGS. 5C and D are sketches that show the same components as the SPECIAL PIVOTING SUPPORT FOR A PURPLE MARTIN HOUSE 31 is lowered to the ground position.

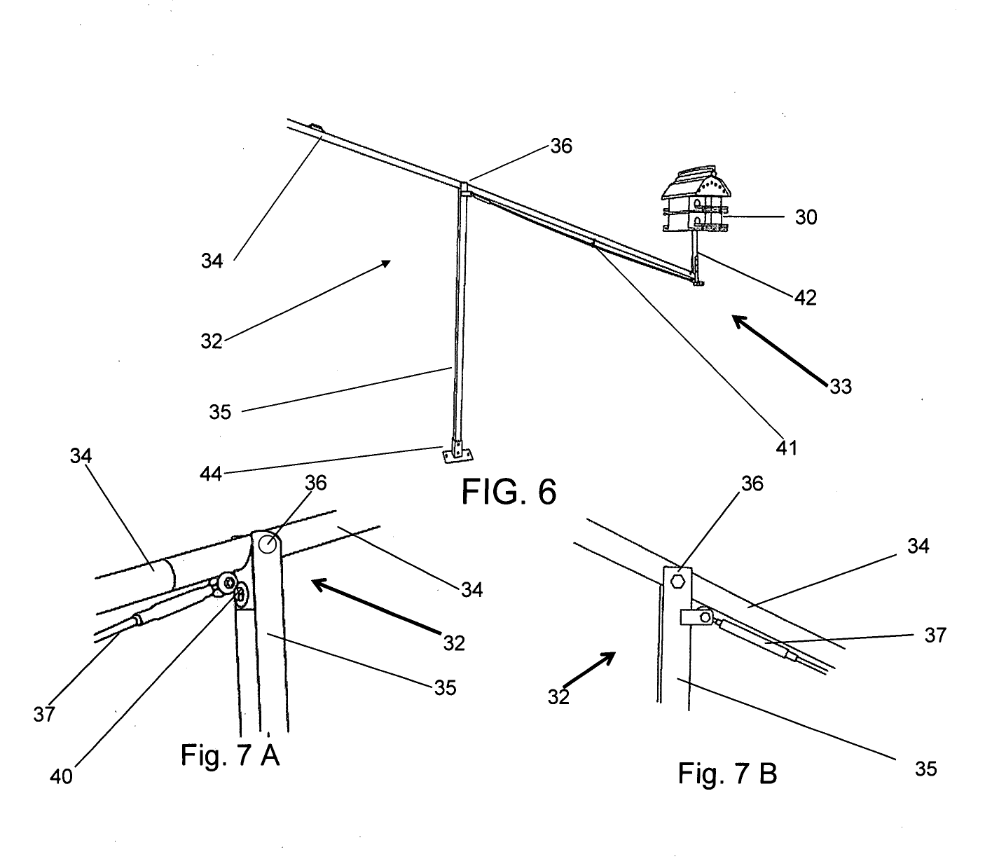

FIG. 6 is a sketch of the prototype SPECIAL PIVOTING SUPPORT FOR A PURPLE MARTIN HOUSE device 31 in its lowered position. This view shows the foundation support plate 44, the channel 35, the pivotal extended support pole 32 and the extended counterbalance pole 34. At the lowered end of the SPECIAL PIVOTING SUPPORT FOR A PURPLE MARTIN HOUSE 31 is the house 30 on the house pole 42 all connected by the pivotal house support 33.

FIGS. 7A and 7B are sketches showing the front and back of the mechanism of a typical pivotal extended pole in the middle section of a SPECIAL PIVOTING SUPPORT FOR A PURPLE MARTIN HOUSE device 31. The vertical channel 35 has the angle adjust 40 supporting the extended pole 34. The pivot means 36 is shown. The adjustable connector 37 runs along the tube 34 to the house pivot support 33.

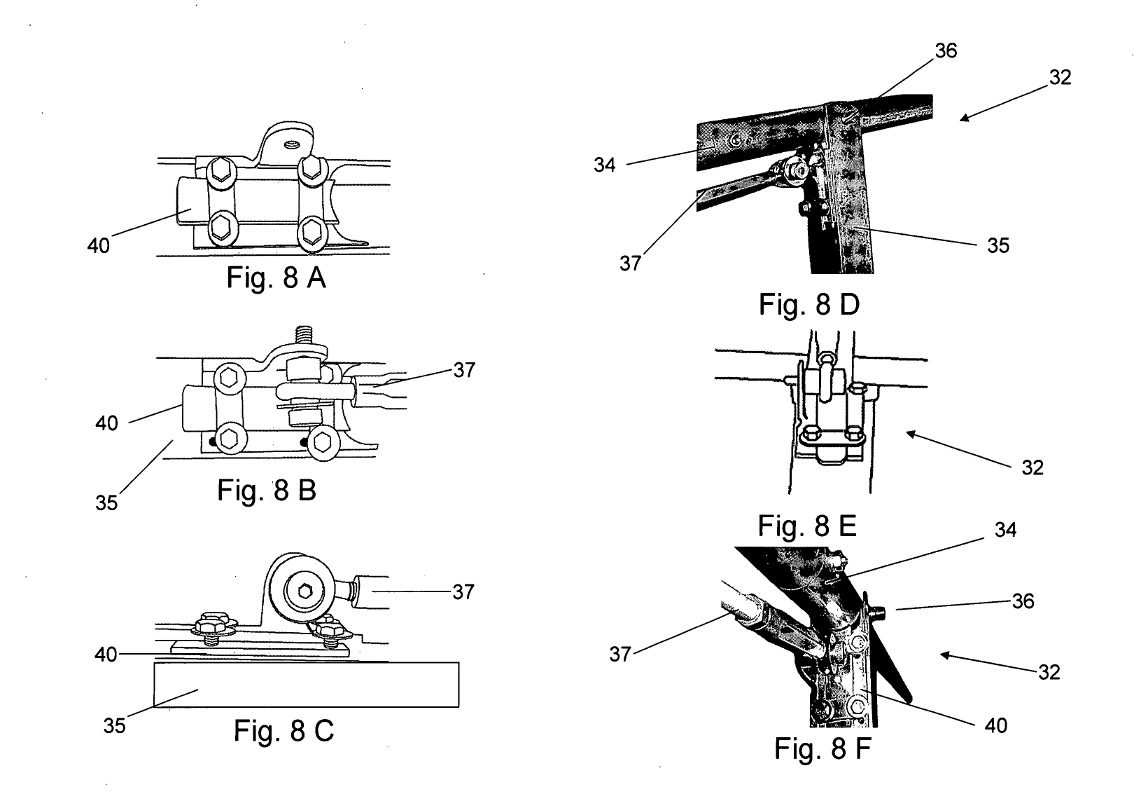

FIGS. 8A through 8F are photographs and sketches showing the detailed components for the pivotal mechanism for the pivotal extended pole 32. FIGS. 8A, B and C show top and side details for the angle adjust 40 and its relation to the connector 37. FIGS. 8D, E and F show the same components in and around the pivotal support 32 in the lowered position. These components and the relationships are examples and not limitations for one skilled in the art to permit a rigid, yet adjustable connection.

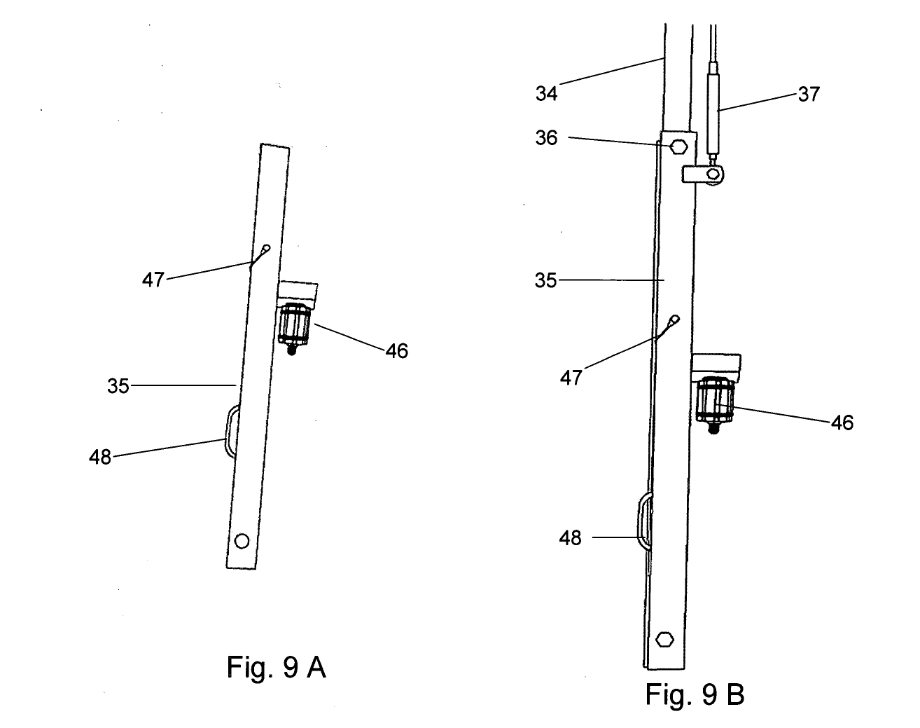

FIGS. 9A and B are sketches of the lower section of the pivotal extended pole 32 including the detailed components for attaching the section 32 to the foundation structure. The tube 34 is internal to the web of the channel 35. A handle 48 permits the operator to grasp the tube 34. A retaining pin 47 or equal retains the tube 34 securely in the channel 35 when the SPECIAL PIVOTING SUPPORT FOR A PURPLE MARTIN HOUSE 31 is in its elevated position. Note the pivot means 36 connecting the tube 34 and the channel 35.

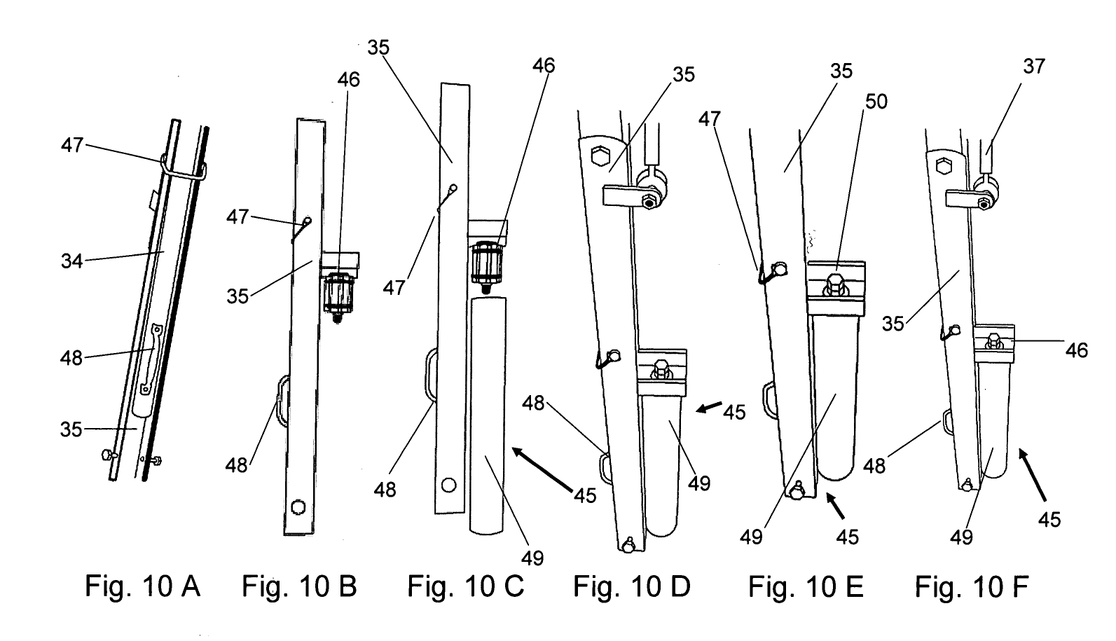

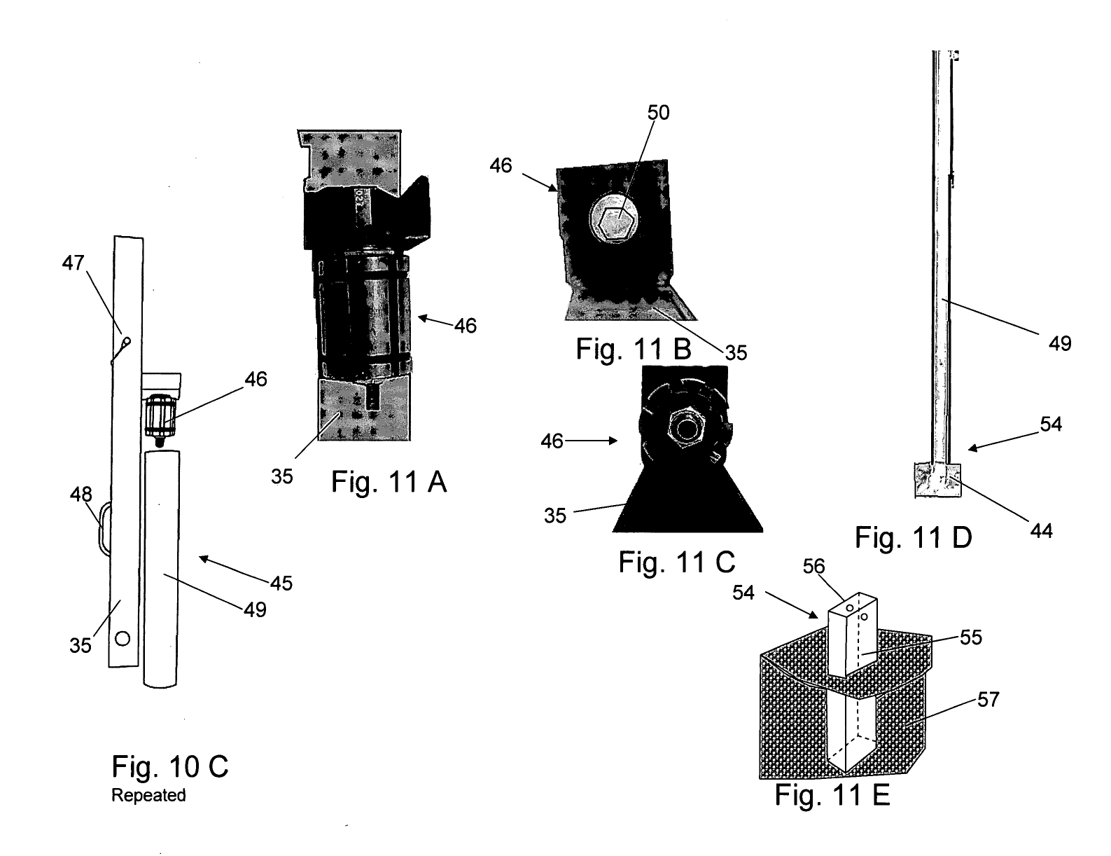

FIGS. 10A through F are sketches of a pivotal extended pole 32 with a connection mechanism to attach it to the foundation structure 45 for use with a fence pole or the like. FIG. 10A shows the tube 34 in the web of the channel 35. FIG. 10B is a side view with the channel 35 attached to the foundation pole connecting means 46. FIG. 10C adds the pole 49 (for a fence or the like) to the view. FIG. 10D continues the interconnection with the foundation fence pole 49 being placed external and contiguous to the means to connect 46. The featured connection means 46 is an adjustable segmented connector that expands and contracts by adjusting the engagement means 50 (shown in FIGS. 10E and F). Once the foundation means 46 is placed internal to the foundation fence pole 49, the adjustment is made to the engagement device 50 and the channel 35, means 46, and tube 49 are rigidly and securely attached.

FIGS. 11A through E are photographs and sketches of connection means between the pivotal extended pole 32 and the fence pole 49 or the preferred foundation system 54. The enlarged views in FIGS. 11A through C show the workings and segmented portions for the connection means 46. The adjustment means 50 is shown in an expanded view in FIG. 11B. FIG. 11D shows the preferred foundation means including the foundation plate 44 and the system 54. The preferred foundation system 54 is depicted in sketch FIG. 11E. Here, the base foundation receiving structure 55 is embedded into a foundation block 57 comprised of concrete, gravel and the like. One skilled in foundation aggregates and concrete understands and appreciates the plethora of means to secure the base foundation receiving structure 55. Finally, the receiving structure 55 contains apertures for securely fastening the channel 35 to the foundation receiver 55. This completes a secure and rigid connection between the channel 35 and the preferred foundation system 54.

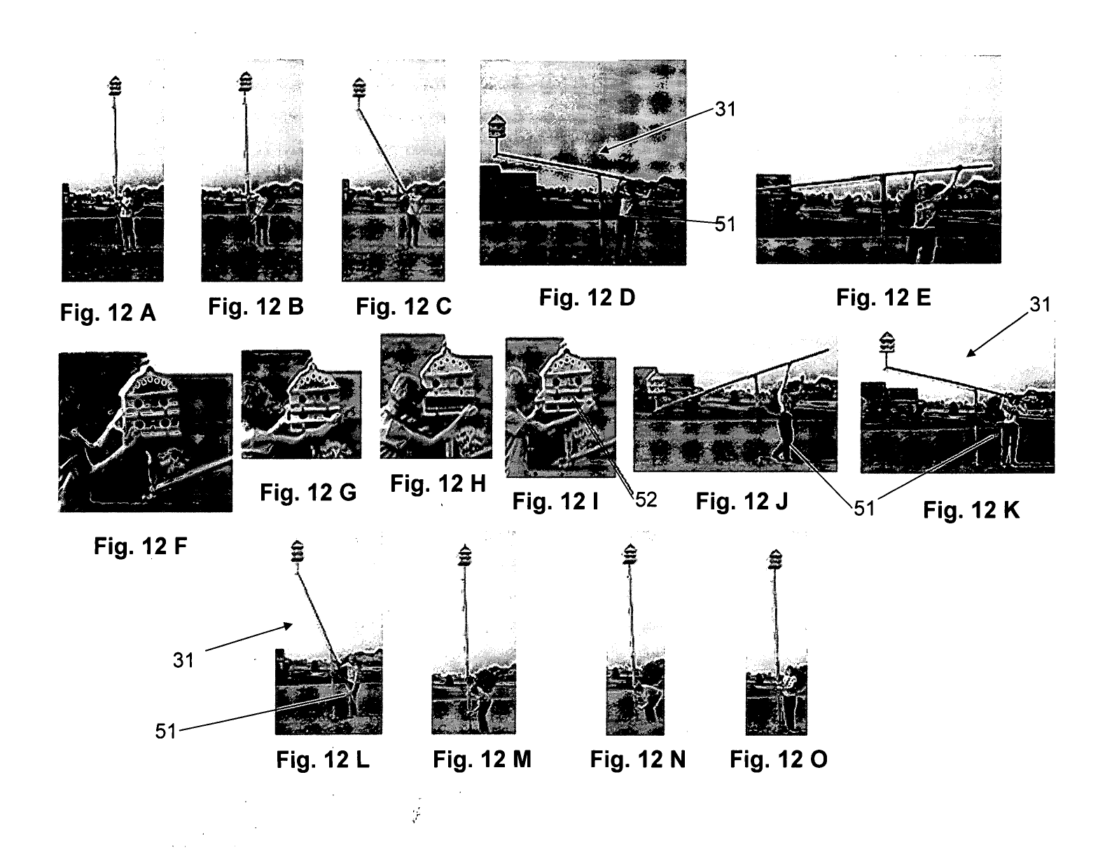

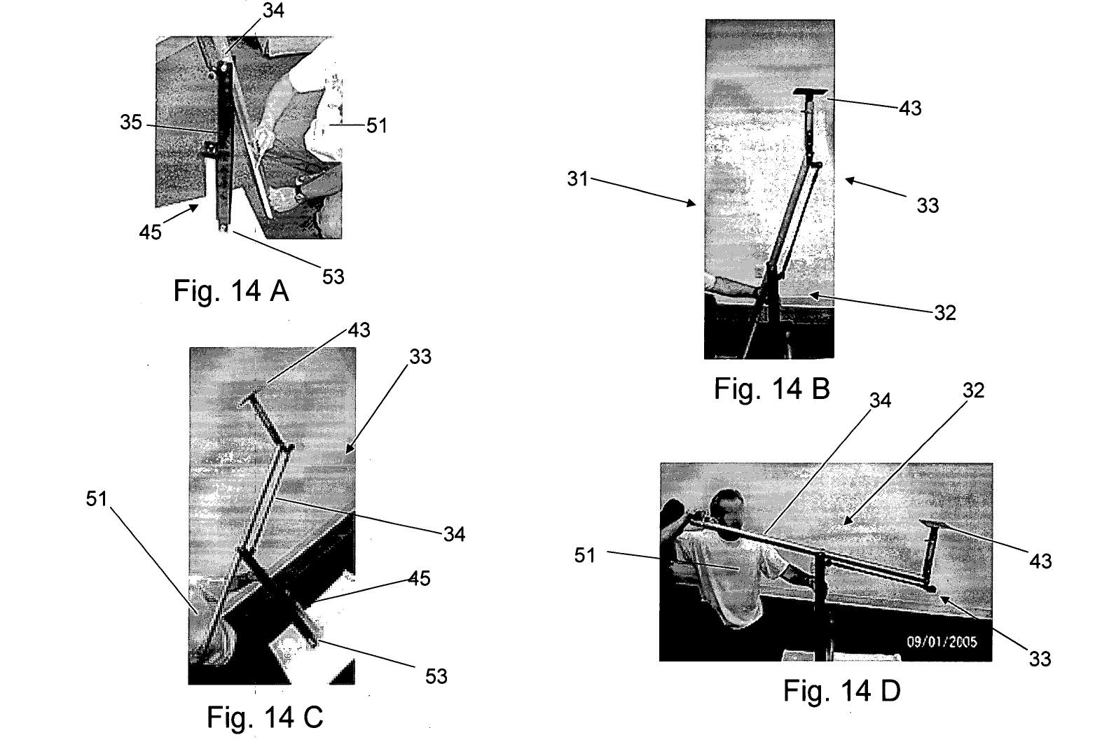

FIGS. 12A through O are photographs of the preferred embodiment of the SPECIAL PIVOTING SUPPORT FOR A PURPLE MARTIN HOUSE device 31 in its full operation. FIGS. 14 A through D are photographs of an operation of an alternative embodiment for a balcony or fence post as the foundation structure. These are described fully in the operation section, below.

FIGS. 13A, B, and C are photographs of an alternative embodiment for mounting to a fence post or balcony rail. Here, an alternative support connector 53 “receives” the channel 35 directly. There is no need for the other connection means 46. This type of connection might serve well for modified support needs for an application on a balcony, condo or the like. One skilled in the art of connection and support mechanisms appreciates that the configuration of the connector 53 will need to be similar or able to simulate the geometrical configuration of the channel or tube being connected. For example, a square tube or a channel might need a connector 53 with a rectangular opening. A circular tube or a triangular tube would need a connector 53 with a circular or triangular opening, respectively.

The details mentioned here are exemplary and not limiting. Other specific components specific to describing a SPECIAL PIVOTING SUPPORT FOR A PURPLE MARTIN HOUSE 31 may be added as a person, having ordinary skill in the field of bird house and purple martin house supports, well appreciates.

### OPERATION OF THE PREFERRED EMBODIMENT

The new SPECIAL PIVOTING SUPPORT FOR A PURPLE MARTIN HOUSE 31 has been described in the above embodiment. The manner of how the device operates is described below. One notes well that the description above and the operation described here must be taken together to fully illustrate the concept of SPECIAL PIVOTING SUPPORT FOR A PURPLE MARTIN HOUSE 31. In FIGS. 12 and 14 the operation of the preferred and alternative embodiments are shown.

FIGS. 12A through O are photographs of the preferred embodiment of the SPECIAL PIVOTING SUPPORT FOR A PURPLE MARTIN HOUSE device 31 in its full operation. In all these views, the operator 51 engages the SPECIAL PIVOTING SUPPORT FOR A PURPLE MARTIN HOUSE 31 to raise and lower the house 30. The operation is summarized in TABLE A.

TABLE A
Method of Operation

| Step | Description |
|---|---|
| 12A | Operator 51 grasps handle 48 |
| 12B | Operator 51 pulls retainer pin 47 |
| 12C | Operator 51 begins to lower SPECIAL PIVOTING SUPPORT |
| | FOR A PURPLE MARTIN HOUSE 31 |
| 12D | Operator 51 continues process of lowering the SPECIAL |
| | PIVOTING SUPPORT FOR A PURPLE MARTIN HOUSE 31 |
| 12E | Operator 51 has SPECIAL PIVOTING SUPPORT FOR A |
| | PURPLE MARTIN HOUSE 31 at lowest position |
| 12F | Operator 51 approaches purple martin house 30 |
| 12G | Operator 51 unlatches purple martin house 30 door 52 |
| 12H | Operator 51 inspects the purple martin house 30 as a |
| | bird survey or to replenish the feed |
| 12I | Operator 51 re-latches purple martin house 30 door 52 |
| 12J | Operator 51 returns to end of the SPECIAL PIVOTING |
| | SUPPORT FOR A PURPLE MARTIN HOUSE 31 opposite the |
| | bird house 30 |
| 12K | Operator 51 begins to elevate the SPECIAL PIVOTING |
| | SUPPORT FOR A PURPLE MARTIN HOUSE 31 by lowering the |
| | extended pole 34 |
| 12L | Operator 51 continues to elevate the house 30 |
| 12M | Operator 51 aligns extended pole 34 with channel 35 |
| 12N | Operator 51 replaces retaining pin 47 |
| 12O | Operator 51 releases extended pole 34 and SPECIAL |
| | PIVOTING SUPPORT FOR A PURPLE MARTIN HOUSE 31 is |
| | in the fully elevated position |

FIGS. 14A through D are photographs of an operation of an alternative embodiment for a balcony or fence post as the foundation structure. In FIG. 14A, the operator 51 unlatches the retainer pin 47 and begins to lower the extended pole 34. In FIG. 14B the lowering process continues. One notes that the house platform 43 pivots around the house support 33 and the house support 43 remains level with the ground/floor. The process continues in FIG. C as the pole 34 is lowered. The process is completed in FIG. 14D as the house support 43 is in its lowered position.

With this description it is to be understood that the SPECIAL PIVOTING SUPPORT FOR A PURPLE MARTIN HOUSE 31 is not to be limited to the disclosed embodiment. The features of the SPECIAL PIVOTING SUPPORT FOR A PURPLE MARTIN HOUSE 31 are intended to cover various modifications and equivalent arrangements included within the spirit and scope of the description.

What is claimed as new and desired to be protected by Letters Patent is:

1. A pivotable support structure for a bird house, comprising:
(a) a support platform for the bird house with a perpendicular support pole integrally connected at one end to the platform;
(b) an extended pole with an upper and lower end and with a counterbalanced section at the lower end of the extended pole;
(c) a means to pivotally connect an end opposite the platform of the support pole and the upper end of the extended pole;
(d) a means to rigidly secure the house support to the extended pole in a fully vertical position;
(e) a base structural member;
(f) a means to pivotally connect the extended pole to a base structural member approximately at a point of balance for the extended pole;
(g) a means to rigidly secure the extended pole to the base member in a vertical position;
(h) a means to secure the base member to the foundation; and,
(i) a foundation means connecting the complete support structure to a near-ground level
whereby the support structure for the bird house is easily pivoted to the near-ground level by a person for access to the bird house and then returned to a fully vertical and secured position with the base structure, extended pole and support pole in a nearly collinear position.

2. The device according to claim 1 wherein the foundation means connecting the complete support structure to a near-ground level is an in ground concrete mass poured around the base support structure.

3. The device according to claim 1 wherein the foundation means connecting the complete support structure to a near-ground level is a plate fastened to the base structure and connected securely to an in ground concrete mass poured around the base support structure.

4. The device according to claim 1 wherein the foundation means connecting the complete support structure to a near-ground level is a mechanical fastener securely connecting the base structure to the top of a fencepost.

5. The device according to claim 1 wherein the means to rigidly secure the house support to the extended pole in a fully vertical position is a structural member with a lower end securely and adjustably connected to the extended pole near to and above the balance point of the extended pole and the upper end connected to a latch means
Whereby the latch means may release the pivotal pole support and permit the platform to pivot and always remain horizontal during raising and lowering the complete support structure for a bird house.

6. The device according to claim 5 wherein the structural member is a threaded rod.

7. The device according to claim 5 wherein the structural member is a tube with an adjusting means at the lower end and a fastening means for the latch at the upper end.

8. A pivotable support structure for a bird house, comprising:
(a) a support platform for the bird house with a perpendicular support pole integrally connected at one end to the platform;
(b) an extended pole with an upper and lower end and with a counterbalanced section at the lower end of the extended pole;
(c) a pin fastened through apertures in the lower end of the support pole and the upper end of the extended pole;
(d) a tube with an adjusting means at the lower end and a fastening means for a means to rigidly latch the pole support vertically;
(e) a base structural channel member;
(f) a pin through apertures at the top of the base channel and through apertures in the extended pole near the balance point of the extended pole;
(g) a means to removably and rigidly secure the extended pole to the base channel near the balance point;
(h) a means to secure the base member to the foundation; and,
(i) a foundation means connecting the complete support structure to a near-ground level
whereby the support structure for the bird house is easily pivoted to the near-ground level by a person for access to the bird house and then returned to a fully vertical and secured position with the base structure, extended pole and support pole in a nearly collinear position.
